(19) United States
(12) Patent Application Publication
(10) Pub. No.: US 2014/0054315 A1
(43) Pub. Date: Feb. 27, 2014

(54) COMPRESSED AIR DISPENSER AND METHODS OF MAKING AND USING THE SAME

(71) Applicant: David A. Neeley, JR., Canton, GA (US)

(72) Inventor: David A. Neeley, JR., Canton, GA (US)

(21) Appl. No.: 13/864,886

(22) Filed: Apr. 17, 2013

Related U.S. Application Data
(60) Provisional application No. 61/693,363, filed on Aug. 27, 2012.

(51) Int. Cl. B67D 7/00; B05B 11/00

(52) U.S. Cl. CPC F17C 7/00
USPC 222/3; 222/78

(57) ABSTRACT

Compressed air dispensers and method of making and using the same are disclosed.

### CROSS-REFERENCE TO RELATED APPLICATIONS

This patent application claims the benefit of priority to U.S. provisional patent application Ser. No. 61/693,363 entitled “COMPRESSED AIR DISPENSER AND METHODS OF MAKING AND USING THE SAME” filed on Aug. 27, 2012, the subject matter of which is incorporated herein in its entirety.

### FIELD OF THE INVENTION

The present invention relates to compressed air dispensers and methods of making and using compressed air dispensers.

### BACKGROUND OF THE INVENTION

The usual method of extinguishing candles on a cake is orally, using your mouth to blow out the candles. The oral method of blowing out candles poses sanitary problems. Children and adults can carry many infectious diseases that are transmitted orally. The most common of these infectious diseases is influenza, commonly referred to as the “flu” or “the common cold.” The flu can be orally transmitted thru the air from one person to the other. Once infected by the flu or other infectious diseases, breathing in the close proximity to another person or blowing out candles on a cake pose threats to many people. The infected air that is used to blow out candles is transferred onto the cake and is then consumed by other individuals thereby infecting them also.

Another means of transmitting infectious diseases is orally by means of saliva. As many children and adults blow out candles on a cake, the air that is orally expelled is mixed with saliva particles. These saliva particles land on the cake, infecting some individuals that consume the cake. Many young children risk sickness by eating birthday cake that is infected with tainted air or saliva.

There have been attempts in the past to remedy this situation by mechanical means. Some of these mechanical devices are blown thru by the individual blowing out the candles, so the air or breath from the individual is passed thru this mechanical device and onto the cake. The problem with this method of transfer is that it still uses the individuals own breath or surrounding air which may be infected to blow out the candles. Another method uses a mechanical device that incorporates a pump that uses the surrounding air to pump air out a nozzle and onto the cake. Again, the problem with this device is that it uses the surrounding air, which by being in close proximity to an infected individual, could also be infected.

There exists a need in the art of a device for blowing out candles, and a method of blowing out candles that eliminates or minimizes the chances of contaminating a birthday cake.

### SUMMARY OF THE INVENTION

The present invention is directed to novelty compressed air dispensers and methods of making and using novelty compressed air dispensers. The novelty compressed air dispensers of the present invention provide an alternative method of extinguishing candles on a cake; dusting a computer; computer keyboard; or a variety of other uses that require compressed air. Unlike other known devices, the novelty compressed air dispensers of the present invention use sealed compressed air to extinguish candles on a cake. The air used in the novelty compressed air dispensers of the present invention can be, but is not limited to, sanitized, sterilized, or standard compressed air.

The compressed air delivery method is accomplished by using a cylinder or cartridge of compressed air much like an inhaler that someone would use for respiratory problems or like that used for air rifles or paint ball guns; these are commonly known as CO₂ cartridges. Instead of using medicines like that of an inhaler or CO₂ like that found in a CO₂ cartridge, the cylinders or cartridges used in the present invention can be clean sanitized air. The advantage of using this method is that it does not use air in the proximity of a cake or the individual blowing out candles, nor does it use the air that is transmitted orally from an individual. The air used in the novelty compressed air dispensers of the present invention is fully enclosed in a sealed cylinder, cartridge or any other type of container. This sanitized air is isolated from any external threats to include infectious airborne diseases either in the proximity of a cake or that is expelled orally from an individual onto a cake.

Once all the compressed air has been used to extinguish candles on a cake, the novelty compressed air dispenser may become a toy for a child to play with or a keepsake to remind the child or adult of that event. The novelty compressed air dispenser can also be used as a duster to clean a computer, computer keyboard, or several other items that require cleaning using compressed air. The novelty compressed air dispensers of the present invention comes in many shapes and sizes to include but not limited to animals, musical instruments, sports equipment, cars, airplanes, etc. The advantage of this is it provides an individual many choices of expression to suit their own tastes as one may be a cat lover and may prefer a novelty compressed air dispenser in the shape of a cat. The same can be said for dogs, horses, airplanes, cars, trumpets, etc.

The novelty compressed air device may be disposable or non-disposable. In some embodiments, the novelty compressed air device becomes disposable once all the compressed air has been used up and there is no means of replenishing the compressed air canister. In other embodiments, the novelty compressed air device is reusable or non-disposable. A novelty compressed air device that is non-disposable will give an individual the means to replace the depleted compressed air canister with a new one.

Accordingly, the present invention is directed to compressed air dispensers. In one exemplary embodiment, the compressed air dispenser of the present invention comprises a compressed air dispenser comprising: a dispenser housing (also referred to herein as a “chassis”) having an internal volume, an outer surface surrounding the internal volume, and at least one opening within the outer surface; a compressed air canister sized so as to be positioned within the internal volume; a trigger mechanism positioned along the outer surface, the trigger mechanism being operatively adapted to enable a fluid contained within the compressed air canister to exit the compressed air canister and travel though the at least one opening in response to a force applied onto the trigger mechanism by a user.

The present invention is further directed to methods of making compressed air dispensers. In one exemplary embodiment, the method of making a compressed air dispenser of the present invention comprises forming a dispenser housing having an internal volume, an outer surface surrounding the internal volume, and at least one opening within the outer surface; and positioning a compressed air canister within the internal volume so that a trigger mechanism positioned along the outer surface can be activated so as to enable a fluid contained within the compressed air canister to exit the compressed air canister and travel though the at least one opening in response to a force applied onto the trigger mechanism by a user.

The present invention is even further directed to methods of using compressed air dispensers. In one exemplary embodiment, the method of using a compressed air dispenser of the present invention comprises pointing any one of the herein-disclosed compressed air dispensers at an object; and moving a trigger mechanism of the compressed air dispenser so as to cause compressed air to be expelled from the dispenser housing of the compressed air dispenser and directed toward the object. For example, the object may comprise a birthday cake or a computer or computer component (e.g., a keyboard).

These and other features and advantages of the present invention will become apparent after a review of the following detailed description of the disclosed embodiments and the appended claims.

### BRIEF DESCRIPTION OF THE FIGURES

The present invention is further described with reference to the appended figures showing exemplary embodiments of the present invention, wherein:

FIG. 1a provides a perspective view of an exemplary compressed air dispenser of the present invention, shown extinguishing candles on a cake;

FIG. 1b provides a perspective view of the exemplary compressed air dispenser shown in FIG. 1a, shown dusting a computer;

FIG. 1c provides a perspective view of the exemplary compressed air dispenser shown in FIG. 1a;

FIG. 1d provides a cross-sectional view of the exemplary compressed air dispenser shown in FIG. 1a as viewed along a length thereof;

FIG. 1e provides a side view of the exemplary compressed air dispenser shown in FIG. 1a as viewed along a length thereof; and

FIGS. 2-9 provide perspective views of eight additional exemplary compressed air dispensers of the present invention, each of which being shown blowing compressed gas.

### DETAILED DESCRIPTION OF THE INVENTION

The present invention is directed to novelty compressed air dispenser and methods of making and using novelty compressed air dispenser. In particular, the present invention is directed to novelty compressed air dispenser as shown in the figures, as described in the various embodiments shown and described herein, and as recited in the claims below.

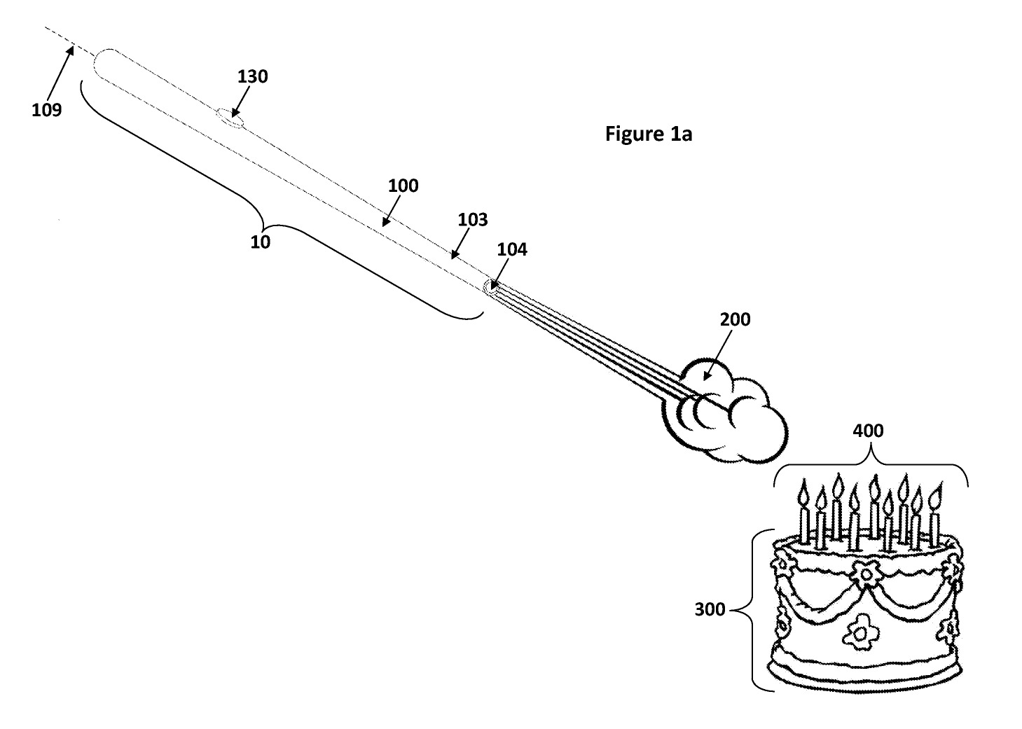

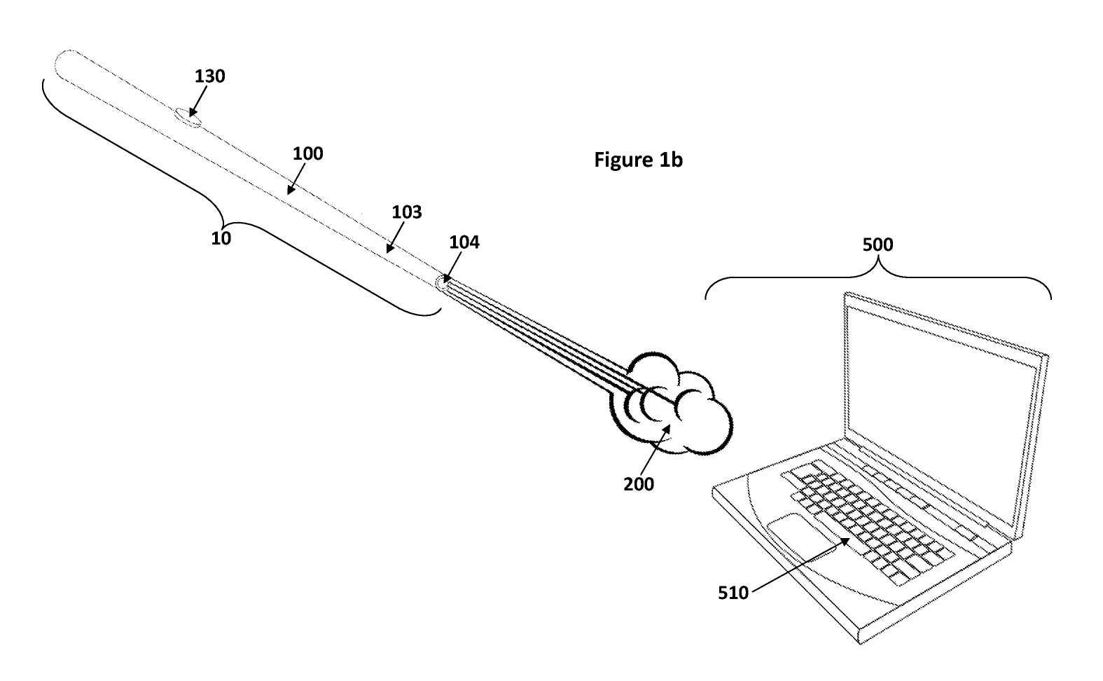

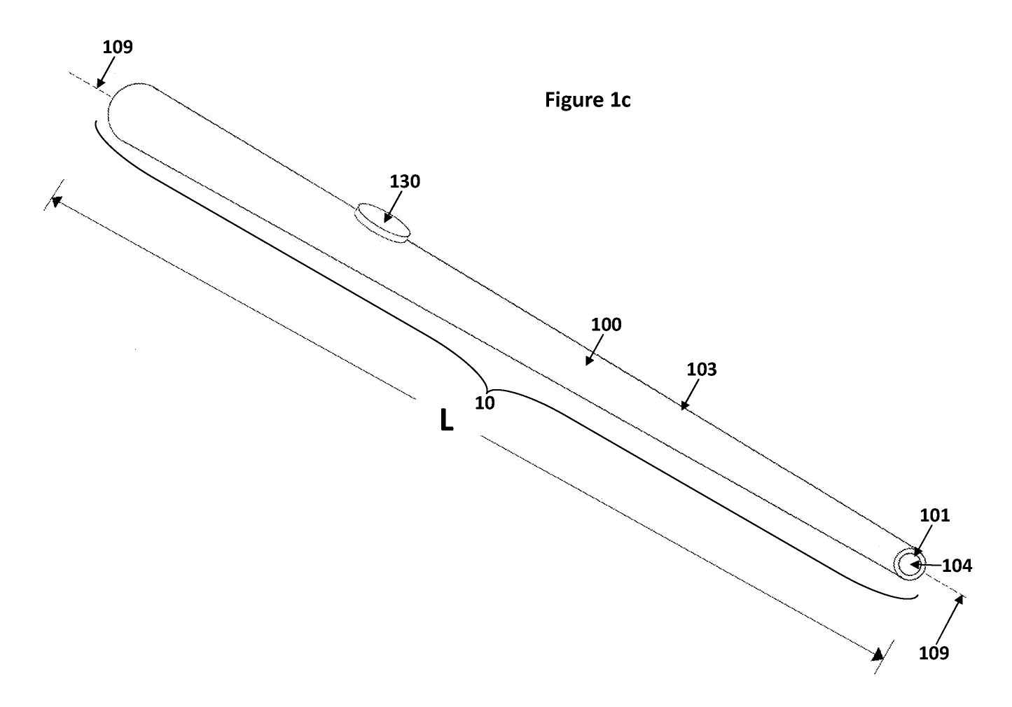

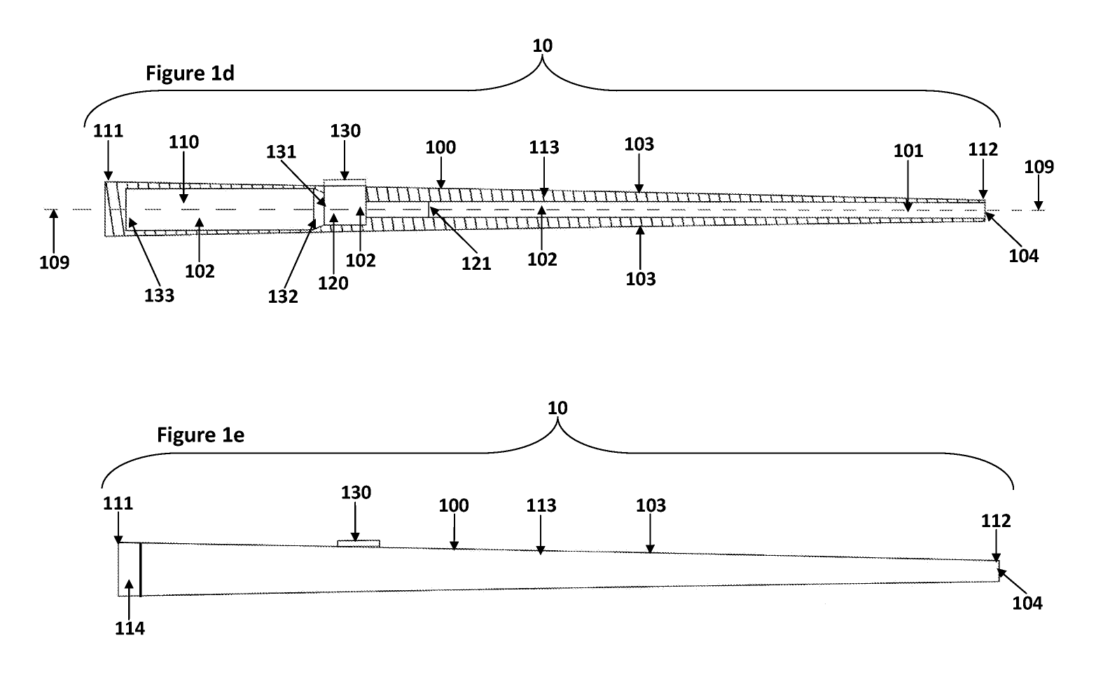

In some embodiments, the compressed air dispenser 10 is comprised of four basic components: a dispenser housing (also referred to herein as a “chassis”) 100 as shown in FIGS. 1a-9; compressed air canister 110 as shown in FIGS. 1d-9; nozzle 120 as shown in FIGS. 1d-9; and nozzle button (also referred to herein as “trigger mechanism”) 130 as shown in FIGS. 1a-9. In other embodiments, compressed air dispenser 10 also comprises a channel 101 as shown in FIGS. 1c-1d.

Dispenser housing 100 forms the main component of compressed air dispenser 10. Dispenser housing 100 holds compressed air canister 110, nozzle 120, and trigger mechanism 130 when fully assembled. Compressed air canister 110, nozzle 120, and trigger mechanism 130 may be located or situated anywhere within dispenser housing 100 either vertically, horizontally, at an angle, forward, aft, top, bottom, left, right, or center.

Some compressed air dispensers 10 of the present invention will have channel 101 located within dispenser housing 100 as shown in FIG. 1d. Channel 101 is a hollow opening or channel that runs internally along dispenser housing 100 either horizontally or vertically or both horizontally and vertically depending on the shape of dispenser housing 100. The length of channel 101 is determined by the distance that compressed air (also referred to herein as “fluid” or “compressed fluid”) 200 has to travel from its point of origin, compressed air canister 110, to its exit near a forward section of dispenser housing 100. Channel 101 allows compressed air 200 released from compressed air canister 110 to escape out and be directed in a uniform pattern onto whatever the user is aiming at.

The geometry of dispenser housing 100 may, if desired be substantially rectangular and elongated or any other suitable shape. Dispenser housing 100 may, if desired, be cut, formed, or molded together into one solid, seamless, and uniform piece. Dispenser housing 100 may, if desired, be manufactured from any type of suitable material. The material may, if desired, be of homogeneous composition, multi-composition of varying degrees, or laminated material. The material may, if desired, be rigid or have varying degrees of rigidity disposed along its longitudinal length. The material may be selected from plastic, steel, wood, graphite, aluminum, fiberglass or other material. Typically, dispenser housing 100 is formed from a polymeric material, such as polyethylene or polypropylene.

The length and width of dispenser housing 100 may be of any desired dimension to accommodate compressed air canister 110, nozzle 120, and trigger mechanism 130. Dispenser housing 100 holds compressed air canister 110, nozzle 120, and trigger mechanism 130.

Compressed air canister 110 contains and stores compressed air 200. Compressed air canister 110 releases its contents of compressed air 200 thru nozzle 120 and out of dispenser housing 100 either directly or via channel 101. The geometry of compressed air canister 110 may, if desired be substantially rectangular and elongated or any other suitable shape. Compressed air canister 110 may, if desired, be cut, formed, or molded together into one solid, seamless, and uniform piece. Compressed air canister 110 may, if desired, be manufactured from any type of suitable material. The material may, if desired, be of homogeneous composition, multi-composition of varying degrees, or laminated material. The material may, if desired, be rigid or have varying degrees of rigidity disposed along its longitudinal length. The material may be selected from plastic, steel, wood, graphite, aluminum, fiberglass or other material. Typically, compressed air canister 110 is formed from a metal material, such as aluminum.

The length and width of compressed air canister 110 may be of any desired dimension to accommodate dispenser housing 100; channel 101 (when present), nozzle 120, and trigger mechanism 130.

Nozzle 120 is mounted on a forward end of compressed air canister 110 and contains a valve that remains closed until opened by an individual pressing down on trigger mechanism 130. Once compressed air 200 is released from compressed air canister 110, nozzle 120 directs air either directly out of dispenser housing 100 or into channel 101.

The geometry of nozzle 120 may, if desired, be substantially round or any other suitable shape. Nozzle 120 may, if desired, be cut, formed, or molded together into one solid, seamless, and uniform piece. Nozzle 120 may, if desired, be manufactured from any type of suitable material. The material may, if desired, be of homogeneous composition, multi-composition of varying degrees, or laminated material. The material may, if desired, be rigid or have varying degrees of rigidity disposed along its longitudinal length. The material may be selected from plastic, steel, wood, graphite, aluminum, fiberglass or other material. Typically, nozzle 120 is formed from a metal material, such as aluminum, or a polymeric material such as polypropylene.

The length and width of nozzle 120 may be of any desired dimension to accommodate dispenser housing 100 and trigger mechanism 130. Nozzle 120 serves at least two purposes; first, to hold in position trigger mechanism 130 and the valve used to release compressed air 200 from within compressed air canister 110; second, to direct compressed air 200 leaving the compressed air canister 110 into a streamlined, uniform, and forward direction.

Trigger mechanism 130 serves as a trigger that, when pressed upon (or moved) by the user's hand, fingers, etc., will contact and open (or cause to open) a valve located within nozzle 120 thereby releasing compressed air 200 stored in compressed air canister 110. The geometry of trigger mechanism 130 may, if desired be substantially round or any other suitable shape. Trigger mechanism 130 may, if desired, be cut, formed, or molded together into one solid, seamless, and uniform piece.

Trigger mechanism 130 may, if desired, be manufactured from any type of suitable material. The material may, if desired, be of homogeneous composition, multi-composition of varying degrees, or laminated material. The material may, if desired, be rigid or have varying degrees of rigidity disposed along its longitudinal length. The material may be selected from plastic, steel, wood, graphite, aluminum, fiberglass or other material. Typically, trigger mechanism 130 is formed from a metal material, such as aluminum, or a polymeric material such as polypropylene.

The length and width of trigger mechanism 130 may be of any desired dimension to accommodate dispenser housing 100 and nozzle 120. Trigger mechanism 130 serves at least one purpose, namely, to enable opening of a valve located within nozzle 120, thereby releasing compressed air 200 stored within compressed air canister 110.

Some versions of the novelty compressed air dispenser will have trigger mechanism 130 integrated into the finger keys of a musical instrument like on a trumpet, clarinet, flute, etc. This allows compressed air 200 to be released from compressed air canister 110 by pushing down on the finger keys as if you were playing a real musical instrument.

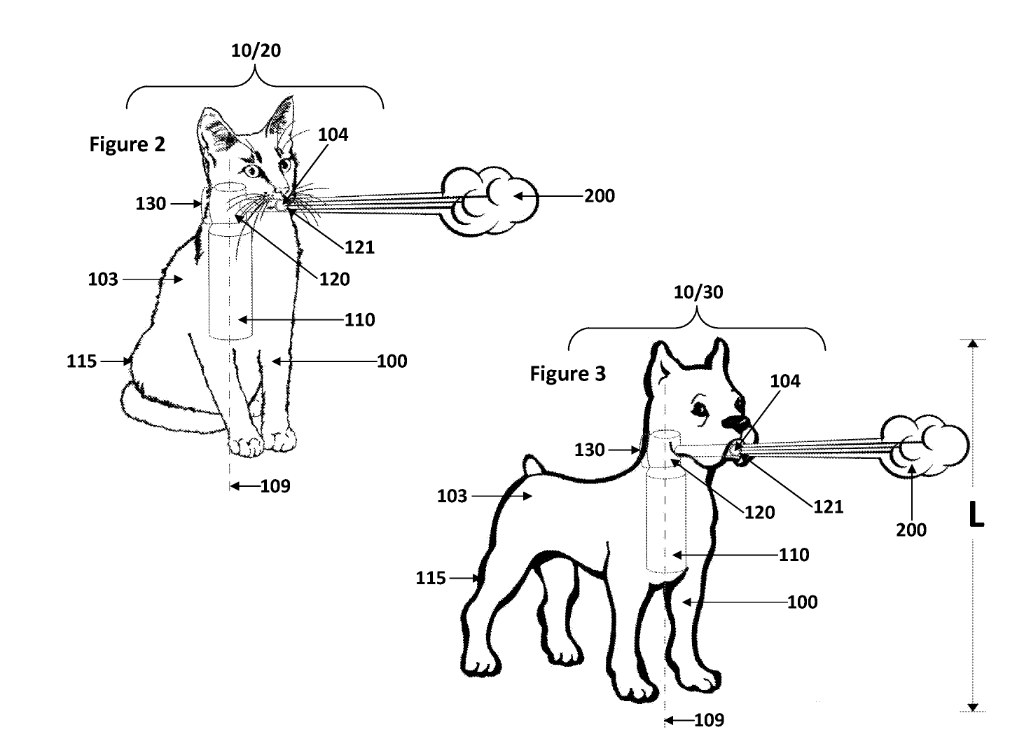

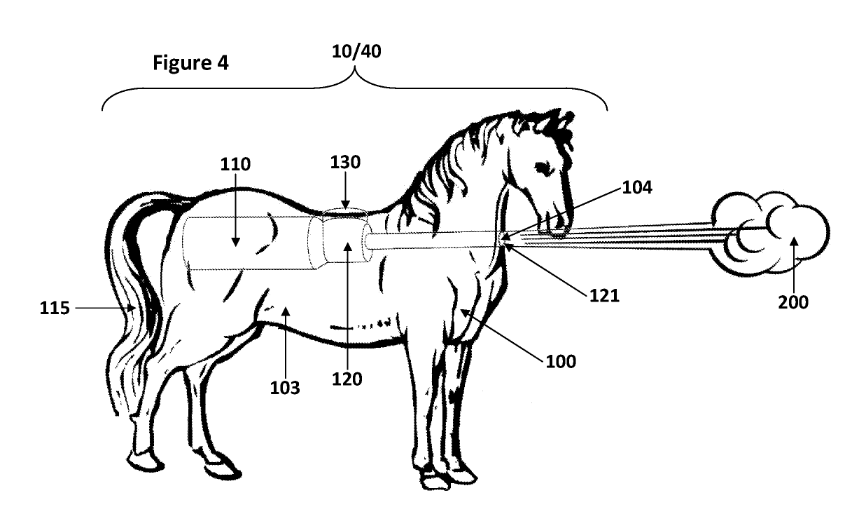

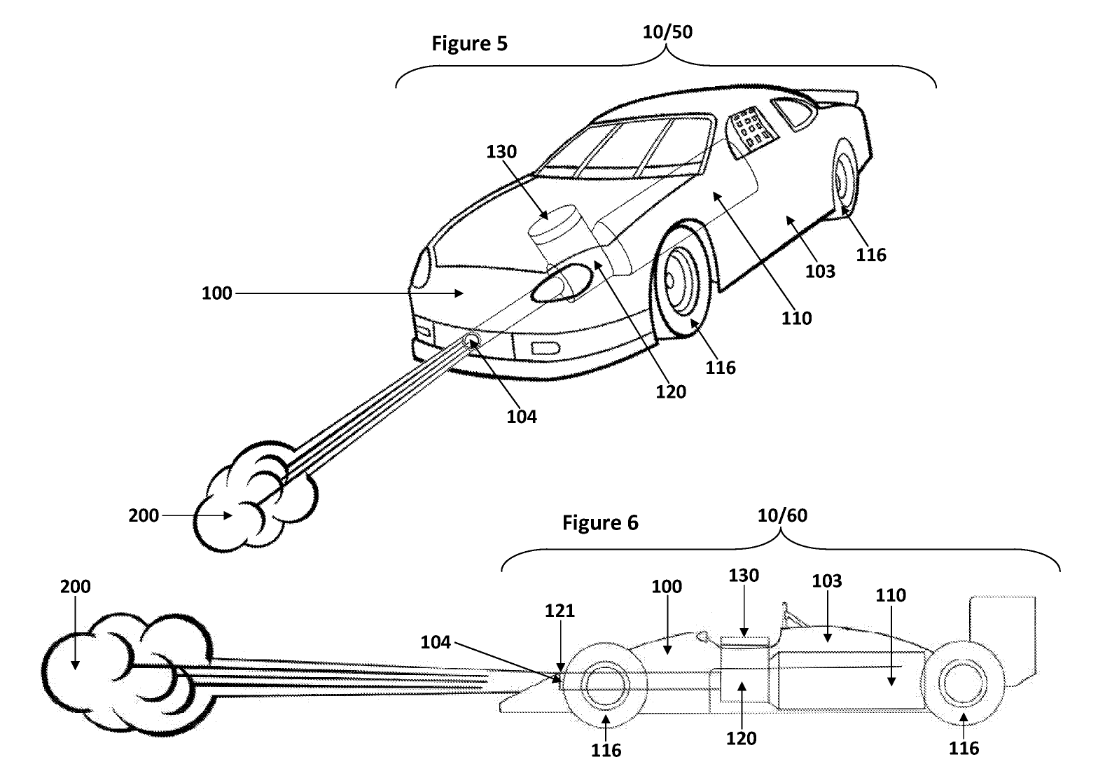

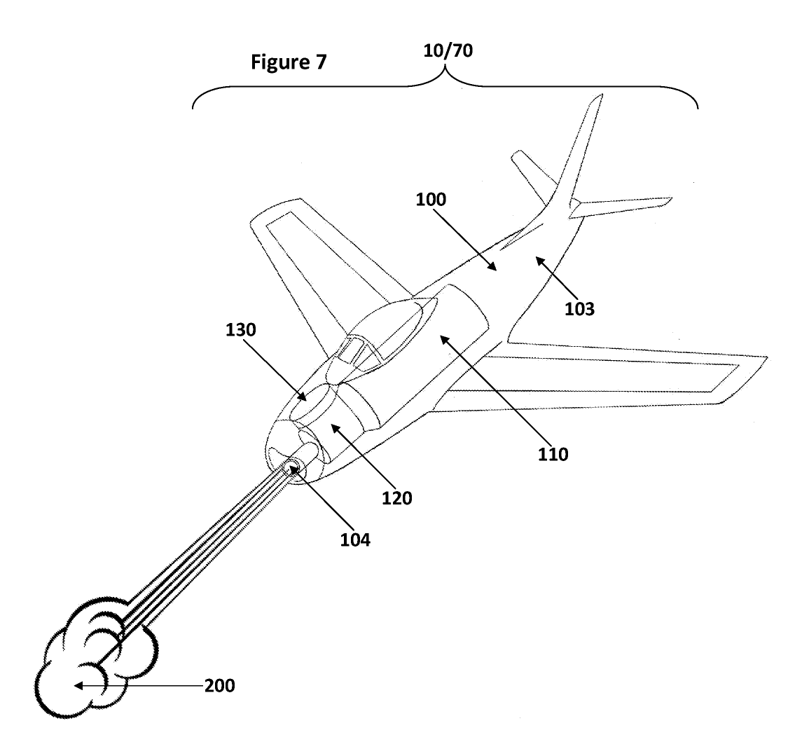

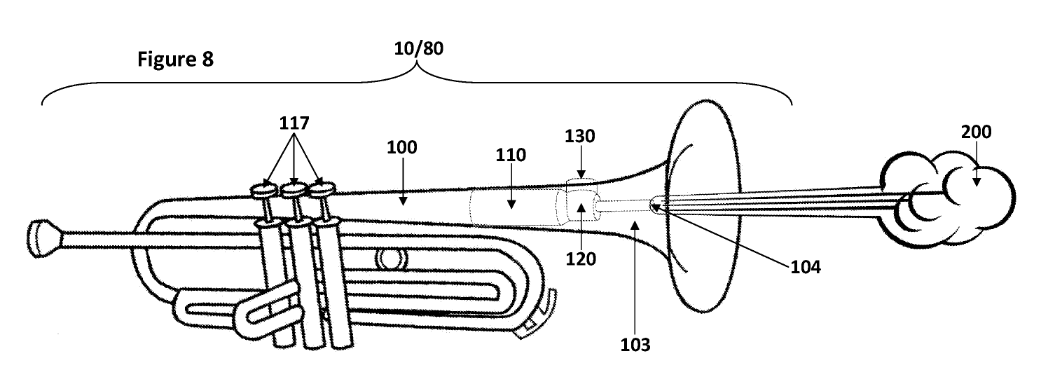

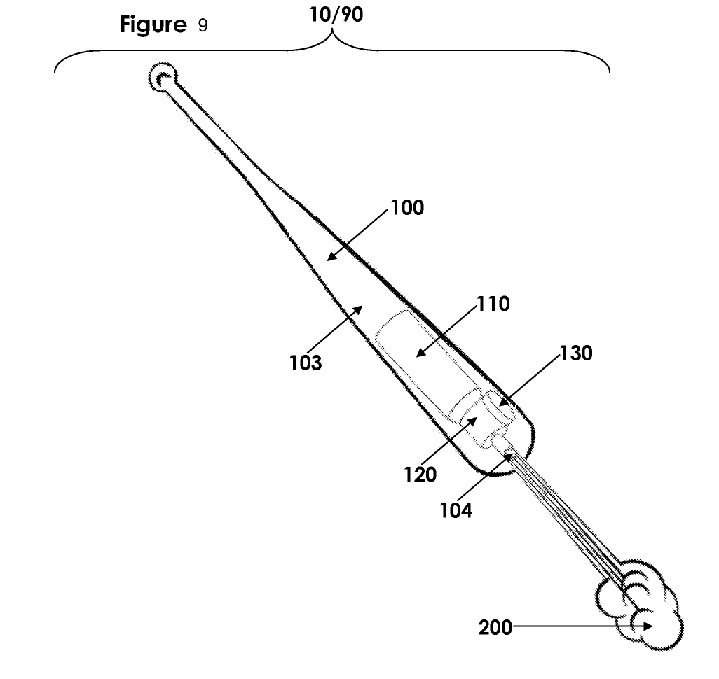

Compressed air dispensers 10 of the present invention may come in various shapes and sizes including, but not limited to, a wand 10 (e.g., a magician's wand), animals, cars, airplanes, musical instruments, sports equipment, etc. Examples of various novelty compressed air dispensers of the present invention are shown as: wand 10 as shown in FIGS. 1a-1e; a cat 20 as shown in FIG. 2; a dog 30 as shown in FIG. 3; a horse 40 as shown in FIG. 4; a stock car 50 as shown in FIG. 5; an Indy car 60 as shown in FIG. 6; an airplane 70 as shown in FIG. 7; a trumpet 80 as shown in FIG. 8; and a baseball bat 90 as shown in FIG. 9.

Any of the above-described components may be formed using conventional techniques. For example, many, if not all, of the above-described components may be thermoformed (e.g., molded) from the above-mentioned materials, and subsequently joined to and/or assembled with one another so as to result in any one of the above-described compressed air dispensers of the present invention.

### Other Embodiments

### Compressed Air Dispensers

1. A compressed air dispenser 10 comprising: a dispenser housing 100 (also referred to herein as a chassis 100) having an internal volume 102, an outer surface 103 surrounding said internal volume 102, and at least one opening 104 within said outer surface 103; a compressed air canister 110 sized so as to be positioned within said internal volume 102; and a trigger mechanism 130 positioned along said outer surface 103, said trigger mechanism 130 being operatively adapted to enable a fluid 200 contained within said compressed air canister 110 to exit said compressed air canister 110 and travel through said at least one opening 104 in response to a force applied onto said trigger mechanism 130 by a user (not shown).

2. The compressed air dispenser 10 of embodiment 1, further comprising: a nozzle 120 positioned within said dispenser housing 100, said nozzle 120 extending a distance from an outlet 131 of said compressed air canister 130.

3. The compressed air dispenser 10 of embodiment 2, wherein said nozzle 120 extends vertically from said outlet 131 of said compressed air canister 130 so as to expel fluid 200 within said compressed air canister 130 in a direction parallel with an axis 109 extending through a length L of said compressed air dispenser 10.

4. The compressed air dispenser 10 of embodiment 2, wherein said nozzle 120 extends substantially perpendicular relative to said outlet 131 of said compressed air canister 130 so as to expel fluid 200 within said compressed air canister 130 in a direction substantially perpendicular to an axis 109 extending though a length L of said compressed air dispenser 10.

5. The compressed air dispenser 10 of any one of embodiments 2 to 4, wherein a distal end 121 of said nozzle 120 is proximate said at least one opening 104 of said dispenser housing 100.

6. The compressed air dispenser 10 of any one of embodiments 1 to 4, further comprising: a channel 101 extending through said dispenser housing 100 and representing a portion of said internal volume 102, said channel 101 extending from proximate said compressed air canister 110 to said at least one opening 104 of said dispenser housing 100.

7. The compressed air dispenser 10 of embodiment 6, wherein said channel 101 extends from a distal end 121 of said nozzle 120 to said at least one opening 104 of said dispenser housing 100.

8. The compressed air dispenser 10 of any one of embodiments 1 to 7, wherein said at least one opening 104 of said dispenser housing 100 comprises a single opening 104.

9. The compressed air dispenser 10 of any one of embodiments 1 to 8, wherein said compressed air canister 110 contains a compressed fluid 200 therein.

10. The compressed air dispenser 10 of any one of embodiments 1 to 9, wherein said compressed air canister 110 contains a compressed fluid 200 therein, said compressed fluid 200 comprising sterilized air.

11. The compressed air dispenser 10 of any one of embodiments 1 to 10, wherein said dispenser housing 100 has a housing first end 111 and a housing second end 112 opposite said housing first end 111; said compressed air canister 110 has an outlet 131 at a canister first end 132 and a canister second end 133 opposite said canister first end 132, and said compressed air canister 110 is positioned within said dispenser housing 100 such that said canister second end 133 is proximate said housing first end 111, and said at least one opening 104 of said dispenser housing 100 is proximate said housing second end 112.

12. The compressed air dispenser 10 of embodiment 11, wherein fluid 200 within said compressed air canister 130 exits said compressed air dispenser 10 along a fluid path extending in a direction parallel with an axis 109 extending through a length L of said compressed air dispenser 10.

13. The compressed air dispenser 10 of embodiment 11 or 12, wherein said trigger mechanism 130 is positioned along a side surface 113 between said housing first end 111 and said housing second end 112.

14. The compressed air dispenser 10 of any one of embodiments 1 to 13, wherein said dispenser housing 100 comprises a removable cover 114 that provides access to said compressed air canister 110 positioned within said internal volume 102 of said dispenser housing 100.

15. The compressed air dispenser 10 of any one of embodiments 1 to 14, wherein said dispenser housing 100 comprises (or consists of) two components, said two components comprising (or consisting of) (1) said dispenser housing 100 and (2) a removable cover 114 that provides access to said compressed air canister 110 positioned within said internal volume 102 of said dispenser housing 100.

16. The compressed air dispenser 10 of any one of embodiments 1 to 13, wherein said dispenser housing 100 is disposable (i.e., the compressed air canister 110 is not replaceable, e.g., due to the design of the dispenser housing 100).

17. The compressed air dispenser 10 of any one of embodiments 1 to 16, wherein said dispenser housing 100 comprises a polymeric material.

18. The compressed air dispenser 10 of embodiment 17, wherein said polymeric material comprises polyethylene, polypropylene, polyester, or any combination thereof.

19. The compressed air dispenser 10 of any one of embodiments 1 to 18, wherein said dispenser housing 100 is shaped as a wand 10.

20. The compressed air dispenser 10 of any one of embodiments 1 to 18, wherein said dispenser housing 100 is shaped as an animal 20/30/40.

21. The compressed air dispenser 10 of any one of embodiments 1 to 18, wherein said dispenser housing 100 is shaped as a cat 20.

22. The compressed air dispenser 10 of any one of embodiments 1 to 18, wherein said dispenser housing 100 is shaped as a dog 30.

23. The compressed air dispenser 10 of any one of embodiments 1 to 18, wherein said dispenser housing 100 is shaped as a horse 40.

24. The compressed air dispenser 10 of any one of embodiments 20 to 23, wherein said outer surface 103 of said dispenser housing 100 is at least partially covered with synthetic animal hair 115.

25. The compressed air dispenser 10 of any one of embodiments 1 to 18, wherein said dispenser housing 100 is shaped as a vehicle (e.g., stock car) 50.

26. The compressed air dispenser 10 of any one of embodiments 1 to 18, wherein said dispenser housing 100 is shaped as a vehicle (e.g., Indy car) 60.

27. The compressed air dispenser 10 of any one of embodiments 1 to 18, wherein said dispenser housing 100 is shaped as an airplane 70.

28. The compressed air dispenser 10 of any one of embodiments 25 to 27, wherein said compressed air dispenser 10 further comprises one or more wheels 116 attached to said dispenser housing 100.

29. The compressed air dispenser 10 of any one of embodiments 1 to 18, wherein said dispenser housing 100 is shaped as a music instrument (e.g., trumpet) 80. Note, although not shown in FIG. 8, one of keys/plungers 117 could act as trigger mechanism 130.

30. The compressed air dispenser 10 of any one of embodiments 1 to 18, wherein said dispenser housing 100 is shaped as a baseball bat 90.

31. The compressed air dispenser 10 of any one of embodiments 1 to 30, wherein said dispenser housing 100 is a hand-held device.

32. The compressed air dispenser 10 of any one of embodiments 1 to 31, wherein said dispenser housing 100 is a toy.

Methods of Making Compressed Air Dispensers:

33. A method of making the compressed air dispenser 10 of any one of embodiments 1 to 31, said method comprising: forming the dispenser housing 100 (e.g., via one or more thermoforming or molding steps, such as one or more injection molding steps).

34. The method of embodiment 33, further comprising: positioning a compressed air canister 110 within the internal volume 102 of the dispenser housing 100.

Methods of Using Compressed Air Dispensers:

35. A method of using the compressed air dispenser 10 of any one of embodiments 1 to 31, said method comprising: pointing the compressed air dispenser 10 at an object 400/500/510; and moving the trigger mechanism 130 so as to cause compressed air 200 to be expelled from the dispenser housing 100 and directed toward the object 400/500/510.

36. The method of embodiment 35, wherein the object 400/500/510 comprises a birthday cake 400.

37. The method of embodiment 35, wherein the object 400/500/510 comprises a computer 500 or computer component (e.g., a keyboard 510).

38. The method of any one of embodiments 35 to 37, said method further comprising: replacing a used/empty compressed air canister 110 with a replacement compressed air canister 110 within the internal volume 102 of the dispenser housing 100.

39. The method of any one of embodiments 35 to 38, said method further comprising: utilizing the dispenser housing 100, with or without a partially used or empty compressed air canister 110 therein, as a toy.

It should be understood that although the above-described compressed air dispensers, kits, and methods are described as “comprising” one or more components or steps, the above-described compressed air dispensers, kits, and methods may “comprise,” “consists of,” or “consist essentially” of any of the above-described components, features or steps of the compressed air dispensers, kits, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a compressed air dispenser, a kit, and/or method that “comprises” a list of elements (e.g., components, features or steps) is not necessarily limited to only those elements (or components or steps), but may include other elements (or components or steps) not expressly listed or inherent to the compressed air dispenser, kit, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a compressed air dispenser, a kit, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described compressed air dispensers, kits, and methods may comprise, consist essentially of, or consist of any of the herein-described components and features, as shown in the figures with or without any feature(s) not shown in the figures. In other words, in some embodiments, the compressed air dispensers, kits, and/or methods of the present invention do not have any additional features other than those shown in the figures, and such additional features, not shown in the figures, are specifically excluded from the compressed air dispensers, kits, and/or methods. In other embodiments, the compressed air dispensers, kits, and/or methods of the present invention do have one or more additional features that are not shown in the figures.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A compressed air dispenser comprising:
a dispenser housing having an internal volume, an outer surface surrounding said internal volume, and at least one opening within said outer surface;
a compressed air canister sized so as to be positioned within said internal volume; and
a trigger mechanism positioned along said outer surface, said trigger mechanism being operatively adapted to enable a fluid contained within said compressed air canister to exit said compressed air canister and travel through said at least one opening in response to a force applied onto said trigger mechanism by a user.

2. The compressed air dispenser of claim 1, further comprising:
a nozzle positioned within said dispenser housing, said nozzle extending a distance from an outlet of said compressed air canister.

3. The compressed air dispenser of claim 2, wherein said nozzle extends vertically from said outlet of said compressed air canister so as to expel fluid within said compressed air canister in a direction parallel with an axis extending through a length of said compressed air dispenser.

4. The compressed air dispenser of claim 2, wherein said nozzle extends substantially perpendicular relative to said outlet of said compressed air canister so as to expel fluid within said compressed air canister in a direction substantially perpendicular to an axis extending though a length of said compressed air dispenser.

5. The compressed air dispenser of claim 2, wherein a distal end of said nozzle is proximate said at least one opening of said dispenser housing.

6. The compressed air dispenser of claim 1, further comprising:
a channel extending through said dispenser housing and representing a portion of said internal volume, said channel extending from proximate said compressed air canister to said at least one opening of said dispenser housing.

7. The compressed air dispenser of claim 6, wherein said channel extends from a distal end of said nozzle to said at least one opening of said dispenser housing.

8. The compressed air dispenser of claim 1, wherein said at least one opening of said dispenser housing comprises a single opening.

9. The compressed air dispenser of claim 1, wherein said compressed air canister contains a compressed fluid therein.

10. The compressed air dispenser of claim 1, wherein said compressed air canister contains a compressed fluid therein, said compressed fluid comprising sterilized air.

11. The compressed air dispenser of claim 1, wherein said dispenser housing has a housing first end and a housing second end opposite said housing first end; said compressed air canister has an outlet at a canister first end and a canister second end opposite said canister first end, and said compressed air canister is positioned within said dispenser housing such that said canister second end is proximate said housing first end, and said at least one opening of said dispenser housing is proximate said housing second end.

12. The compressed air dispenser of claim 11, wherein fluid within said compressed air canister exits said compressed air dispenser along a fluid path extending in a direction parallel with an axis extending through a length of said compressed air dispenser.

13. The compressed air dispenser of claim 11, wherein said trigger mechanism is positioned along a side surface between said housing first end and said housing second end.

14. The compressed air dispenser of claim 1, wherein said dispenser housing comprises a removable cover that provides access to said compressed air canister positioned within said internal volume of said dispenser housing.

15. The compressed air dispenser of claim 1, wherein said dispenser housing comprises two components, said two components comprising (1) said dispenser housing and (2) a removable cover that provides access to said compressed air canister positioned within said internal volume of said dispenser housing.

16. The compressed air dispenser of claim 1, wherein said dispenser housing is disposable.

17. The compressed air dispenser of claim 1, wherein said dispenser housing is a hand-held device.

18. The compressed air dispenser of claim 1, wherein said dispenser housing is shaped as a wand, an animal, a cat, a dog, a horse, a vehicle, a racing car, an airplane, a music instrument, or a baseball bat.

19. The compressed air dispenser of claim 1, wherein said dispenser housing is a toy.

20. A method of making the compressed air dispenser of claim 1, said method comprising:
forming the dispenser housing; and
positioning a compressed air canister within the internal volume of the dispenser housing.

21. A method of using the compressed air dispenser of claim 1, said method comprising:
pointing the compressed air dispenser at an object; and
moving the trigger mechanism so as to cause compressed air to be expelled from the dispenser housing and directed toward the object.

22. The method of claim 21, wherein the object comprises a birthday cake.

23. The method of claim 21, said method further comprising:
replacing a used/empty compressed air canister with a replacement compressed air canister within the internal volume of the dispenser housing.

24. The method of claim 21, said method further comprising:
utilizing the dispenser housing, with or without a partially used or empty compressed air canister therein, as a toy.
